(19) United States
(12) Patent Application Publication
(10) Pub. No.: US 2024/0122429 A1
(43) Pub. Date: Apr. 18, 2024

(54) ELECTRIC ROBOT

(71) Applicant: NINGBO POOLSTAR POOL PRODUCTS CO.,LTD., Ningbo (CN)

(72) Inventor: Liang CHEN, Ningbo (CN)

(21) Appl. No.: 18/395,332

(22) Filed: Dec. 22, 2023

(30) Foreign Application Priority Data
Oct. 20, 2023 (CN) 202322828666.3

(51) Int. Cl. A47L 11/30; A47L 11/40; E04H 4/16

(52) U.S. Cl. CPC A47L 11/302; A47L 11/4002; A47L 11/4027; A47L 11/4066; A47L 11/4069; A47L 2201/04; E04H 4/1654

(57) ABSTRACT

An electric robot includes a housing, an impeller, a suction motor, and a filtering structure. The housing is provided with a water inlet and a water outlet. The impeller is provided in the housing, and located between the water inlet and the water outlet. The suction motor is provided in the housing, and includes a motor main body and a motor shaft provided therein. The impeller is sleevedly provided on the motor shaft. The suction motor is configured to drive the impeller to rotate around an axis of the motor shaft through the motor shaft to generate suction. A rotational speed of the motor shaft is adjustable. The filtering structure is provided in the housing, and is located between the impeller and the water outlet.

### CROSS-REFERENCE TO RELATED APPLICATIONS

This application claims the benefit of priority from Chinese Patent Application No. 202322828666.3, filed on Oct. 20, 2023. The content of the aforementioned application, including any intervening amendments thereto, is incorporated herein by reference in its entirety.

### TECHNICAL FIELD

This application relates to cleaning equipment for artificial pools such as swimming pools, and more particularly to an electric robot.

### BACKGROUND

The commercially-available pool electric robots generally adopt a pre-filtration design due to the limitations of the impeller. Specifically, the filtering device is disposed near the suction port. After the solid waste is filtered out, the clean water passes through the impeller, and in this case, the suction effect is limited. The debris may not be sucked into the pool robot, which leads to poor sewage suction effect.

### SUMMARY

In view of the deficiencies in the prior art, this application provides an electric robot with excellent sewage suction effect.

This application provides an electric robot, including:
a housing;
an impeller;
a suction motor; and
a filtering structure;
wherein the housing is provided with a water inlet and a water outlet;
the impeller is provided in the housing; and the impeller is provided between the water inlet and the water outlet;
the suction motor is provided in the housing; the suction motor comprises a motor main body and a motor shaft provided on the motor main body; the impeller is sleevedly provided on the motor shaft; the suction motor is configured to drive the impeller to rotate around an axis of the motor shaft through the motor shaft to generate suction; and a rotational speed of the motor shaft of the suction motor is adjustable; and
the filtering structure is provided in the housing; and the filtering structure is provided between the impeller and the water outlet.

In an embodiment, the electric robot further includes an accommodating box; wherein the accommodating box is provided in the housing; the accommodating box comprises a motor cavity and an impeller cavity spaced from each other; the motor main body is provided in the motor cavity; the impeller is provided in the impeller cavity; the motor shaft is configured to partially extend into the impeller cavity to be connected to the impeller; and a first end of the impeller cavity is connected to the water inlet, and a second end of the impeller cavity is connected to the filtering structure.

In an embodiment, an outer periphery of the motor shaft is sleevedly provided with a sealing member; and the sealing member is provided between the motor cavity and the impeller cavity to realize sealing between the motor cavity and the impeller cavity.

In an embodiment, the filtering structure comprises a frame and a filter screen disposed at an outer periphery of the frame; and
the frame and the filter screen are correspondingly provided with a flow port; and the impeller cavity is connected to an interior of the frame through the flow port.

In an embodiment, the impeller is provided between the water inlet and the suction motor; or the suction motor is provided between the water inlet and the impeller.

In an embodiment, the electric robot further includes a first travelling motor, a first track wheel, a second travelling motor, and a second track wheel;
wherein the first travelling motor is in transmission connection with the first track wheel; and the second travelling motor is in transmission connection with the second track wheel; and
the first travelling motor and the second travelling motor are provided in the housing; the first track wheel and the second track wheel are provided on opposite sides of the housing, respectively; the first traveling motor is configured to drive the first track wheel to rotate; the second traveling motor is configured to drive the second track wheel to rotate; and each of the first traveling motor and the second traveling motor is configured to perform forward and reverse rotation.

In an embodiment, the electric robot further includes a first roller brush and a second roller brush; and
wherein the first roller brush and the second roller brush are provided at a front end of the housing; the first roller brush is in transmission connection with the first travelling motor; the second roller brush is in transmission connection with the second travelling motor; and the first roller brush and the second roller brush are configured to frictionally rotate relative to a to-be-cleaned surface to clean the to-be-cleaned surface.

In an embodiment, the electric robot further includes a printed circuit board (PCB) control board;
wherein the PCB control board is in transmission connection to the suction motor, the first travelling motor and the second travelling motor; the PCB control board is configured to control the suction motor, the first travelling motor and the second travelling motor to start and stop; the PCB control board is further configured to adjust the rotational speed of the motor shaft; and the PCB control board is also configured for performing switch between forward and reverse rotation of the first traveling motor and the second traveling motor.

In an embodiment, the electric robot further includes a sensor;
wherein the sensor is provided at an outer sidewall of the housing; the sensor is in transmission connection to the PCB control board; the sensor is configured to detect an angle change of the electric robot; the sensor is further configured for, upon detecting that an angle between the electric robot and ground is greater than 30 degrees, sending a first signal to the PCB control board to increase the rotational speed of the motor shaft; and
the sensor is further configured to determine whether the electric robot touches an obstacle or a wall of a pool; and the sensor is configured to, upon detecting that the electric robot touches the obstacle or the wall of the pool, send a second signal to the PCB control board to switch a rotation direction of the first traveling motor and the second traveling motor.

In an embodiment, the sensor is a gyroscope.

This application has the following beneficial effects.

In the actual use, the electric robot provided herein is deployed in the artificial pool (e.g., swimming pool) needed to be cleaned, and the suction motor is started to drive the impeller to rotate around the axis of the motor shaft through the motor shaft to generate suction, such that the sewage near the water inlet is sucked into the housing through the water inlet. The sewage that enters the housing is filtered by the filtering structure, and then discharged through the water outlet. Since the filtering structure is arranged at the rear, the filtering structure or the solid dirt intercepted by the filtering structure will not block the suction force generated by the rotation of the impeller, so as to enhance the suction capacity, and improve the suction efficiency substantially and the applicability. In addition, the rotational speed of the motor shaft is adjustable, such that the rotational speed of the motor shaft can be increased to generate greater suction when encountering stubborn waste, further enhancing the suction capacity. The suction effect is particularly remarkable for leaves, strip garbage and gravel.

### BRIEF DESCRIPTION OF THE DRAWINGS

In order to illustrate the technical solutions in the embodiments of the present disclosure or in the prior art more clearly, the drawings required in the description of the embodiments or the prior art will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a structural diagram of an electric robot according to an embodiment of the present disclosure;

FIG. 2 is a sectional isometric view of the electric robot according to an embodiment of the present disclosure;

FIG. 3 is a schematic diagram showing a combination structure of an impeller and a suction motor according to an embodiment of the present disclosure;

FIG. 4 partially shows a structure of the electric robot according to an embodiment of the present disclosure; and

FIG. 5 is a bottom view of the electric robot according to an embodiment of the present disclosure.

In the figures: 100—housing; 110—water inlet; 120—water outlet; 200—impeller; 210—impeller column; 220—vane; 300—suction motor; 310—motor main body; 320—motor shaft; 400—filtering structure; 410—frame; 411—flow port; 500—accommodating box; 510—motor cavity; 520—impeller cavity; 600—sealing member; 710—first traveling motor; 720—first track wheel; 730—first roller brush; 810—second traveling motor; 820—second track wheel; 830—second roller brush; 900—transmission gear; 1000—waterproof box; 1100—brush strip; 1200—PCB control board; 1300—sensor; 1400—baffle; and 1500—connecting member.

The purpose, functional features and advantages of the present disclosure will be further described with reference to the embodiments and the accompanying drawings.

### DETAILED DESCRIPTION OF EMBODIMENTS

The technical solutions in the embodiments of the present disclosure will be clearly and completely described below in conjunction with the accompanying drawings of the present disclosure. It is clear that described below are merely some embodiments of the disclosure, which are not intended to limit the disclosure. For those skilled in the art, other embodiments obtained based on these embodiments without paying creative efforts should fall within the scope of the disclosure.

As used herein, all orientation terms (such as “upper”, “lower”, “left”, “right”, “front”, “rear” etc.) are only used to explain the relative positional relationship and movement in a particular posture (shown in the accompanying drawings), and the orientation indications are correspondingly changed if the specific posture is changed. In addition, the terms “first” and “second” are merely descriptive, and cannot be understood as indicating or implying relative importance or implicitly specifying the number of technical features indicated. Thus, a feature defined as “first” or “second” may include at least one such feature, either explicitly or implicitly. In addition, “and/or” includes three solutions. For example, A and/or B includes the technical solution A, the technical solution B, and a combination thereof. Furthermore, the technical solutions of various embodiments can be combined with each other on the premise that the combined solution can be implemented by those skilled in the art. When the combination of technical solutions is contradictory or cannot be realized, such a combination does not exist and is not within the scope of the disclosure defined by the present claims.

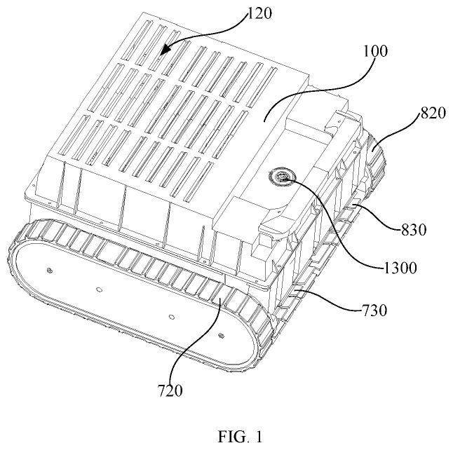

As shown in FIGS. 1-3, an electric robot includes a housing 100, an impeller 200, a suction motor 300, and a filtering structure 400. The housing 100 is provided with a water inlet 110 and a water outlet 120. The impeller 200 is disposed in the housing 100. The impeller 200 is disposed between the water inlet 110 and the water outlet 120. The suction motor 300 is disposed in the housing 100. The suction motor 300 includes a motor main body 310 and a motor shaft 320 provided on the motor main body 310. The impeller 200 is sleevedly disposed in the motor shaft 320. The suction motor 300 drives the impeller 200 to rotate around the axis of the motor shaft 320 through the motor shaft 320 to generate suction. The rotational speed of the motor shaft 320 is adjustable. The filtering structure 400 is provided inside the housing 100, and the filtering structure 400 is provided between the impeller 200 and the water outlet 120.

In the actual use, the electric robot provided herein is deployed in the artificial pool (e.g., swimming pool) needed to be cleaned, and the suction motor 300 is started to drive the impeller 200 to rotate around the axis of the motor shaft 320 through the motor shaft 320 to generate suction, such that the sewage near the water inlet 110 is sucked into the housing 100 through the water inlet 110. The sewage that enters the housing 100 is filtered by the filtering structure 400, and then discharged through the water outlet 120. Since the filtering structure 400 is arranged at the rear, the filtering structure 400 or the solid dirt intercepted by the filtering structure 400 will not block the suction force generated by the rotation of the impeller 200, so as to enhance the suction capacity, and improve the suction efficiency substantially and applicability. In addition, the rotational speed of the motor shaft 320 of the suction motor 300 is adjustable, such that the rotational speed of the motor shaft 320 can be increased to generate greater suction when encountering, further enhancing the suction capacity. The suction effect is particularly remarkable for leaves or strip garbage, and gravel.

The electric robot provided in this disclosure is used in the artificial pools such as swimming pools to clean the pool water in the artificial pools.

Referring to FIGS. 1-2 and 5, the water inlet 110 is provided at the bottom of the housing 100, and the water outlet 120 is provided at the top of the housing 100.

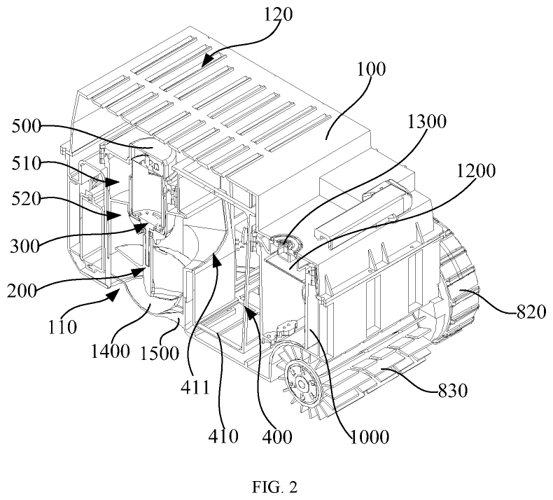

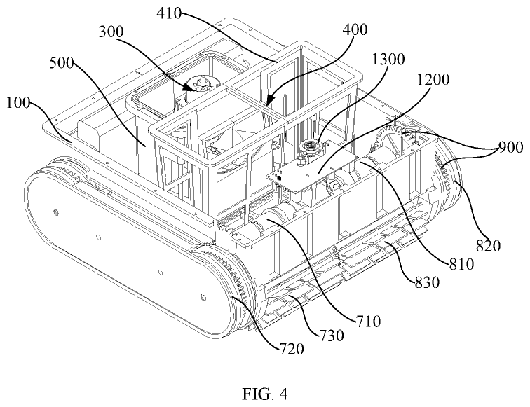

Referring to FIGS. 2 and 4, the electric robot further includes an accommodating box 500. The accommodating box 500 is provided in the housing 100. The accommodating box 500 includes a motor cavity 510 and an impeller cavity 520 spaced from each other. The motor main body 310 of the suction motor 300 is provided in the motor cavity 510. The impeller 200 is provided in the impeller cavity 520. The motor shaft 320 partially extends into the impeller cavity 520 to be connected to the impeller 200. One end of the impeller cavity 520 is connected to the water inlet 110, and the other end of the impeller cavity 520 is connected to the filtering structure 400. In this embodiment, the impeller cavity 520 is a water inlet channel.

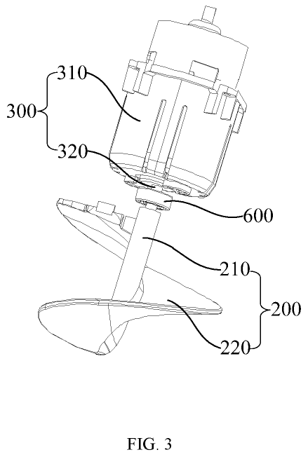

Referring to FIGS. 2-3, the motor shaft 320 is sleevedly provided with a sealing member 600 around the outer periphery of the motor shaft 320. The sealing member 600 is located between the motor cavity 510 and the impeller cavity 520. The sealing member is used to realize the sealing between the motor cavity 510 and the impeller cavity 520, so as to prevent the sewage that enters the impeller cavity 520 from entering the motor cavity 510. In this embodiment, the sealing member 600 is a sealing ring. The sealing ring is an annular structure. The sealing ring is sleeved on the motor shaft 320. The inner peripheral wall of the sealing ring is in close contact with the outer periphery of the motor shaft 320. The outer peripheral wall of the sealing ring is in close contact with the dividing plate between the impeller cavity 520 and the motor cavity 510, so as to realize the sealing between the motor cavity 510 and the impeller cavity 520.

Referring to FIGS. 2 and 4, the filtering structure 400 includes a frame 410 and a filter screen disposed at an outer periphery of the frame 410. The frame 410 and the filter screen are correspondingly provided with a flow port 411. The impeller cavity 520 is connected to the interior of the frame 410 through the flow port 411.

Specifically, sewage near the water inlet 110 enters the impeller cavity 520 via the water inlet 110 under the suction force generated by the impeller 200. Then the sewage inside the impeller cavity 520 flows into the frame 410 of the filtering structure 400, and then flows out after being filtered by the filter screen at the outer periphery of the frame 410, and then flows outside the electric robot through the water outlet 120. In this way, solid materials such as dirt and garbage remain in the frame 410 of the filtering structure 400, and the clean water obtained after the sewage is separated from the dirt and garbage flows out through the mesh of the filter screen.

Referring to FIG. 2, in this embodiment, the impeller 200 is located between the water inlet 110 and the suction motor 300. By such an arrangement, the impeller 200 is closer to the water inlet 110, thereby generating a greater suction force when the impeller 200 rotates. In other embodiments, the suction motor 300 may be disposed between the water inlet 110 and the impeller 200.

Referring to FIG. 2, the impeller 200 is located between the water inlet 110 and the suction motor 300, meaning that the impeller 200 is located below the suction motor 300, such that the impeller 200 is closer to the water inlet 110 at the bottom of the housing 100. At this time, the impeller cavity 520 for accommodating the impeller 200 is located below the motor cavity 510 for accommodating the suction motor 300.

Referring to FIGS. 1 and 4, the electric robot further includes a first traveling motor 710 and a first track wheel 720, and a second traveling motor 810 and a second track wheel 820. The first travelling motor 710 is in transmission connection with the first track wheel 720. The second travelling motor 810 is in transmission connection with the second track wheel 820. The first traveling motor 710 and the second traveling motor 810 are disposed in the housing 100. The first track wheel 720 and the second track wheel 820 are disposed on opposite sides of the housing 100, respectively. The first traveling motor 710 is used to drive the first track wheel 720 to rotate. The second traveling motor 810 is used to drive the second track wheel 820 to rotate. The first traveling motor 710 is configured to perform forward and reverse rotation. The second traveling motor 810 is configured to perform forward and reverse rotation. Specifically, the first traveling motor 710 and the second traveling motor 810 rotate in forward direction at the same time, so as to drive the electric robot forward through the first track wheel 720 and the second track wheel 820. The first traveling motor 710 and the second traveling motor 810 rotate reversely at the same time, so as to drive the electric robot backward through the first track wheel 720 and the second track wheel 820. When one of the first traveling motor 710 and the second traveling motor 810 rotates in forward direction, and the other rotates reversely, the first track wheel 720 and the second track wheel 820 drive the electric robot to turn. In this embodiment, with respect to the rotation direction of the first traveling motor 710 and the second traveling motor 810, the direction of driving the electric robot forward by the corresponding track wheel is the forward direction, and vice versa in the reverse direction.

Referring to FIGS. 1 and 4, the first traveling motor 710 is in transmission connection with the first track wheel 720 via the transmission gear 900. The second traveling motor 810 is in transmission connection with the second track wheel 820 via the transmission gear 900. The transmission gear 900 is a conventional transmission gear in the prior art, and the matching relationship of the transmission gear 900 with the motor and the track wheel is the same as in the prior art.

Referring to FIGS. 2 and 4, the electric robot further includes a waterproof box 1000. The waterproof box 1000 is disposed within the housing 100. The first traveling motor 710 and the second traveling motor 810 are disposed within the waterproof box 1000, thereby avoiding water entering the first traveling motor 710 and the second traveling motor 810.

Referring to FIGS. 2 and 4, the electric robot further includes a first roller brush 730 and a second roller brush 830 disposed at the front end of the housing 100. The first roller brush 730 is in transmission connection with the first traveling motor 710. The second roller brush 830 is in transmission connection with the second traveling motor 810. The first roller brush 730 and the second roller brush 830 can frictionally rotate relative to the to-be-cleaned surface to clean the to-be-cleaned surface. Specifically, the first roller brush 730 and the second roller brush 830 play an auxiliary cleaning role. When some stains or dirt bonds to the to be cleaned surface, the friction between the first roller brush 730 and the to be cleaned surface and the friction between the second roller brush 830 and the to be cleaned surface can clean the stain or dirt from the to be cleaned surface. The suction force generated by the rotation of the impeller 200 sucks the cleaned stains and dirt through the water inlet 110 into the housing 100.

Referring to FIG. 4, the first traveling motor 710 is connected to the first roller brush 730 via the transmission gear 900, and the second traveling motor 810 is connected to the second roller brush 830 via the transmission gear 900.

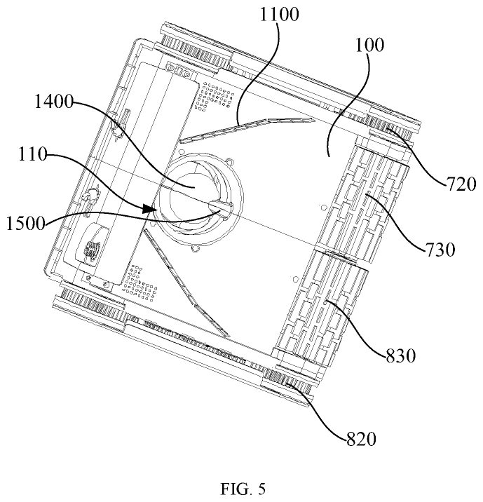

Referring to FIG. 5, a brush strip 1100 is provided at the bottom of the housing 100. The brush strip 1100 is disposed on the side of the water inlet 110 near the tail end of the electric robot, so that when the electric robot is traveling, the brush strip 1100 can gather the dirt near the water inlet 110. In this embodiment, the number of the brush strips 1100 is two. The two brush strips 1100 are provided on both sides of the water inlet 110. The opening distance of the two brush strips 1100 decreases gradually from the first end of the electric robot to the tail end of the electric robot, so that the two brush strips 1100 gather the dirt near the water inlet 110.

Referring to FIGS. 2 and 4, the electric robot further includes a printed circuit board (PCB) control board 1200. The PCB control board 1200 is in transmission connection to the suction motor 300, the first traveling motor 710, and the second traveling motor 810. The PCB control board 1200 is used for controlling the suction motor 300, the first traveling motor 710, and the second traveling motor 810 to start and stop. The PCB control board 1200 is also used for adjusting the rotational speed of the motor shaft 320 of the suction motor 300. The PCB control board 1200 is also used for performing switch between forward and reverse rotation of the first traveling motor 710 and the second traveling motor 810. In this embodiment, the PCB control board 1200 is provided in the waterproof box 1000, thereby avoiding water entering the PCB control board 1200.

Referring to FIGS. 1-2, the electric robot further includes a sensor 1300. The sensor 1300 is disposed in an outer sidewall of the housing 100. The sensor 1300 is in transmission connection to the PCB control board 1200. The sensor 1300 is used to detect the change in angle of the electric robot. The sensor 1300 is used to send a signal to the PCB control board 1200 when it detects that the angle of the electric robot with the ground is greater than 30 degrees, then the PCB control board 1200 increases the rotational speed of the motor shaft 320 of the suction motor 300. Specifically, when the sensor 1300 detects that the angle between the electric robot and the ground is greater than 30 degrees, it indicates that the electric robot begins to climb the wall, and that the first end of the electric robot is cocked. At this time, the rotational speed of the motor shaft 320 of the suction motor 300 is increased, so that the impeller 200 rotates to generate the greater suction force, in turn enabling the electric robot to reliably adsorb on the wall. In this disclosure, the filtering structure 400 is rearwardly placed, and the rotational speed of the motor shaft 320 of the suction motor 300 is increased to strengthen the suction force twice. Thus, the present disclosure can ensure that the electric robot can reliably climb the wall through the suction force generated by the rotation of the impeller 200, and there is no need to rely on the pressure of the water sprayed by the water outlet 120.

Further, when climbing the wall, the first traveling motor 710 and the second traveling motor 810 maintain rotation in forward direction. After a period of rotation in forward direction, the first traveling motor 710 and the second traveling motor 810 simultaneously rotate in the reverse direction, and the suction motor 300 decelerates so as to enable the electric robot to back down from the wall.

When climbing wall, the suction motor 300 is accelerated so that the electric robot adsorbs reliably to the wall. When not climbing the wall, the suction motor 300 decelerates to save energy.

The sensor 1300 can determine whether the electric robot touches an obstacle or the pool wall. The sensor 1300 is used to send a signal to the PCB control board 1200 when it detects that the electric robot encounters the obstacle or the pool wall, whereby the PCB control board 1200 switches the rotation direction of the first traveling motor 710 and the second traveling motor 810.

Further, the sensor 1300 is a gyroscope. Specifically, the gyroscope can detect the angular velocity of the electric robot in the three directions XYZ, so as to determine the motion change of the electric robot in space. In addition, when the gyroscope detects that the acceleration of the electric robot in the three XYZ directions is unchanged, it indicates that the electric robot is not moving. At this time, it can be judged that the electric robot touches the obstacle or the wall of the swimming pool, and then the electric robot can change the travelling direction to continue to clean other areas.

Further, the running trajectory of the electric robot can be set in advance, and the electric robot can be controlled to clean the artificial pool to be cleaned along the preset running trajectory through the cooperation of the sensor 1300 and the PCB control board 1200. Specifically, the sensor 1300 determines whether the electric robot reaches a turn in the running trajectory, and then feeds back to the PCB control board 1200. Then, the PCB control board 1200 controls the suction motor 300, the first traveling motor 710, and the second traveling motor 810 according to the feedback from the sensor 1300, to ensure that the electric robot does not deviate from the preset running trajectory.

Specifically, two preset times may be set. If the sensor 1300 does not detect that the product is tilted at the specified first preset time, the first traveling motor 710 and the second traveling motor 810 are switched to reverse rotation, so as to cause the electric robot to switch the running direction. Or during running process, the first traveling motor 710 and the second traveling motor 810 set one traveling motor to forward rotation and the other traveling motor to reverse rotation according to the second preset time, at which time the electric robot realizes steering.

The suction motor 300 starts first during operation of the electric robot. The first traveling motor 710 and the second traveling motor 810 start after a few seconds.

Referring to FIGS. 2 and 4, the electric robot further includes a baffle 1400. The baffle 1400 is provided in the housing 100. The baffle 1400 is disposed between the impeller 200 and the water inlet 110. The axis extension line of the motor shaft 320 passes through the baffle 1400. Specifically, the baffle 1400 is provided, so that when the sewage enters the housing 100 through the water inlet 110, the sewage will impact on the baffle 1400. Then, the sewage spreads into the housing 100 from the periphery of the baffle 1400. Since the axis extension line of the motor shaft 320 passes through the baffle 1400, the baffle 1400 covers the end of the motor shaft 320 close to the baffle 1400. Thus, the garbage in the sewage will not be entangled in the end of the motor shaft 320 close to the baffle 1400, thereby avoiding many leaves or strips of garbage entangling in the motor shaft 320 and slowing down the rotational speed of the drive member, thereby avoiding the garbage in the sewage from affecting the suction efficiency.

The electric robot further includes a power supply structure which supplies power to the electric robot.

Referring to FIGS. 2 and 4, the electric robot further includes a connecting member 1500. One end of the connecting member 1500 is connected to the baffle 1400, and the other end of the connecting member 1500 is connected to the inner wall of the housing 100.

In an embodiment, the connecting member 1500 is integrally molded with the baffle 1400. Specifically, the connecting member 1500 is fastened to the inner wall of the housing 100 by screws or to the inner wall of the housing 100 by spring fastener.

Referring to FIG. 2, the outer peripheral profile of the baffle 1400 is a gradually narrowing curved surface from the end close to the impeller 200 to the end away from the impeller 200. Specifically, the periphery of the end of the baffle 1400 away from the impeller 200 (referring to the bottom end of the baffle 1400) is relatively narrow. The periphery of the end of the baffle 1400 close to the impeller 200 (referring to the top end of the baffle 1400) is relatively wide. Thus, the effluent from the bottom end of the baffle 1400 towards the top end of the baffle 1400 gradually spreads towards the periphery of the baffle 1400. Consequently, when the sewage is just flowing towards the impeller 200, the sewage is farther away from the axis of the motor shaft 320, which further avoids the garbage in the sewage from entangling on the end of the motor shaft 320 near the baffle 1400.

The baffle 1400 may, but is not limited to, be a hemispherical structure, a conical structure, or a parabolic structure. In this embodiment, referring to FIG. 1, the baffle 1400 is a hemispherical structure.

Referring to FIG. 2, the baffle 1400 is a rotary body. The axis of the motor shaft 320 coincides with the axis of the baffle 1400. Specifically, when the sewage flows from the bottom end of the baffle 1400 towards the top end of the baffle 1400, the sewage gradually spreads towards the periphery of the baffle 1400. Because the axis of the motor shaft 320 coincides with the axis of the baffle 1400, the surrounding sewage is relatively far from the axis of the motor shaft 320.

Referring to FIGS. 2-3, the impeller 200 includes an impeller column 210 and a vane 220. The impeller column 210 is sleeved on the motor shaft 320. The vane 220 is spirally coiled on the impeller column 210. Specifically, the vane 220 is spirally coiled, which facilitates conveying upwardly the garbage in the sewage.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. An electric robot, comprising:
a housing;
an impeller;
a suction motor; and
a filtering structure;
wherein the housing is provided with a water inlet and a water outlet;
the impeller is provided in the housing; and the impeller is provided between the water inlet and the water outlet;
the suction motor is provided in the housing; the suction motor comprises a motor main body and a motor shaft provided on the motor main body; the impeller is sleevedly provided on the motor shaft; the suction motor is configured to drive the impeller to rotate around an axis of the motor shaft through the motor shaft to generate suction; and a rotational speed of the motor shaft of the suction motor is adjustable; and
the filtering structure is provided in the housing; and the filtering structure is provided between the impeller and the water outlet.

2. The electric robot of claim 1, further comprising:
an accommodating box;
wherein the accommodating box is provided in the housing; the accommodating box comprises a motor cavity and an impeller cavity spaced from each other; the motor main body is provided in the motor cavity; the impeller is provided in the impeller cavity; the motor shaft is configured to partially extend into the impeller cavity to be connected to the impeller; and a first end of the impeller cavity is connected to the water inlet, and a second end of the impeller cavity is connected to the filtering structure.

3. The electric robot of claim 2, wherein an outer periphery of the motor shaft is sleevedly provided with a sealing member; and the sealing member is provided between the motor cavity and the impeller cavity to realize sealing between the motor cavity and the impeller cavity.

4. The electric robot of claim 2, wherein the filtering structure comprises a frame and a filter screen disposed at an outer periphery of the frame; and
the frame and the filter screen are correspondingly provided with a flow port; and the impeller cavity is connected to an interior of the frame through the flow port.

5. The electric robot of claim 1, wherein the impeller is provided between the water inlet and the suction motor; or the suction motor is provided between the water inlet and the impeller.

6. The electric robot of claim 1, further comprising:
a first travelling motor;
a first track wheel;
a second travelling motor; and
a second track wheel;
wherein the first travelling motor is in transmission connection with the first track wheel; and the second travelling motor is in transmission connection with the second track wheel; and
the first travelling motor and the second travelling motor are provided in the housing; the first track wheel and the second track wheel are provided on opposite sides of the housing, respectively; the first traveling motor is configured to drive the first track wheel to rotate; the second traveling motor is configured to drive the second track wheel to rotate; and each of the first traveling motor and the second traveling motor is configured to perform forward and reverse rotation.

7. The electric robot of claim 6, further comprising:
a first roller brush; and
a second roller brush;
wherein the first roller brush and the second roller brush are provided at a front end of the housing; the first roller brush is in transmission connection with the first travelling motor; the second roller brush is in transmission connection with the second travelling motor; and the first roller brush and the second roller brush are configured to frictionally rotate relative to a to-be-cleaned surface to clean the to-be-cleaned surface.

8. The electric robot of claim 6, further comprising:
a printed circuit board (PCB) control board;
wherein the PCB control board is in transmission connection to the suction motor, the first travelling motor and the second travelling motor; the PCB control board is configured to control the suction motor, the first travelling motor and the second travelling motor to start and stop; the PCB control board is further configured to adjust the rotational speed of the motor shaft; and the PCB control board is also configured for performing switch between forward and reverse rotation of the first traveling motor and the second traveling motor.

9. The electric robot of claim 8, further comprising:
a sensor;
wherein the sensor is provided at an outer sidewall of the housing; the sensor is in transmission connection to the PCB control board; the sensor is configured to detect an angle change of the electric robot; the sensor is further configured for, upon detecting that an angle between the electric robot and ground is greater than 30 degrees, sending a first signal to the PCB control board to increase the rotational speed of the motor shaft; and
the sensor is further configured to determine whether the electric robot touches an obstacle or a wall of a pool; and the sensor is configured to, upon detecting that the electric robot touches the obstacle or the wall of the pool, send a second signal to the PCB control board to switch a rotation direction of the first traveling motor and the second traveling motor.

10. The electric robot of claim 9, wherein the sensor is a gyroscope.
